(19) United States
(12) Patent Application Publication
(10) Pub. No.: US 2013/0062482 A1
(43) Pub. Date: Mar. 14, 2013

(54) ELECTROSTATIC-FILM ADHESIVE HANGER

(71) Applicant: Ren-Cian Wang, New Taipei City (TW)

(72) Inventor: Ren-Cian Wang, New Taipei City (TW)

(21) Appl. No.: 13/606,729

(22) Filed: Sep. 7, 2012

(30) Foreign Application Priority Data
Sep. 8, 2011 (TW) 100216864

(51) Int. Cl. F16M 13/02

(52) U.S. Cl. 248/205.1

(57) ABSTRACT

An electrostatic-film adhesive hanger is disclosed. The electrostatic-film adhesive hanger includes: an electrostatic-film layer; a transparent protection layer; a printed layer adhered between the electrostatic-film layer and the transparent protection layer, wherein a pattern is arranged on one side of the printed layer facing the transparent protection layer; and a hanger body unit adhered on the external surface of the transparent protection layer. Due to the electrostatic adsorption of the electrostatic-film layer, the whole electrostatic-film adhesive hanger can be steadily adsorbed on the wall without emergency of falling off; the printed layer enables the electrostatic-film adhesive hanger to have visual aesthetics; and the transparent protection layer has a clear perspectivity for the printed layer and is used for protecting the printed layer from damage.

### RELATED APPLICATIONS

This application claims priority to Taiwan Application Serial Number 100216864, filed Sep. 8, 2011, which is herein incorporated by reference.

### BACKGROUND

1. Field of Invention

The present disclosure relates to an adhesive hanger. More particularly the present disclosure relates to an electrostatic-film adhesive hanger.

2. Description of Related Art

In order to hang an object, generally a hanger is mounted on a wall (such as the walls of a living room, a dining room, a kitchen and a bathroom) for hanging or holding the object.

For fixing a conventional hanger, the hanger is nailed on the wall through a steel nail. However, this nailing mode may damage the wall; and when the hanger is detached, a trace may be left on the wall, so that the conventional hanger has the disadvantage of being destructive.

In a sucker-type fixing hanger, the hanger is adsorbed onto the wall with a sucker by using a vacuum adsorption. Due to various factors such as the action of physical recovery or moisture, the sucker can be detached from the wall after being used for a period of time. The service life of the hanger is relatively reduced due to insufficient of service durability.

In a gluing-type fixing hanger, the hanger is adhered on the wall with glue. However, due to various factors such as hardening and mildewing of the glue, the adhesiveness of the glue may be reduced gradually after the glue is used for a period of time, and thus the hanger may gradually fall off from the wall. Therefore, the service durability of the hanger is also insufficient, and thus the service life of the hanger is relatively reduced.

Hence, the utility of the conventional hanger is poor due to the above reasons.

### SUMMARY

In order to solve the above disadvantages of the conventional hanger, the present disclosure aims to provide an electrostatic-film adhesive hanger with fastness and aesthetics.

According to the above purposes, an aspect of the present disclosure provides an electrostatic-film adhesive hanger, including: an electrostatic-film layer having an internal surface and an external surface on a reverse side of the internal surface; a transparent protection layer having an internal surface and an external surface on a reverse side of the internal surface; a printed layer adhered between the internal surface of the electrostatic-film layer and the internal surface of the transparent protection layer, wherein a pattern is arranged on one side of the printed layer facing the transparent protection layer; and a hanger body unit adhered on the external surface of the transparent protection layer. Due to the electrostatic adsorption of the electrostatic-film layer, the whole electrostatic-film adhesive hanger can be adsorbed steadily on the wall without emergency of falling off; the printed layer enables the electrostatic-film adhesive hanger to have a visual aesthetics; and the transparent protection layer has clear perspectivity for the printed layer and is used for protecting the printed layer from damage.

According to an embodiment of the present disclosure, the hanger body unit includes a base and a hanger body. The base is adhered on the external surface of the transparent protection layer. The hanger body is configured on the base for hanging or holding an object to be hanged.

According to another embodiment of the present disclosure, the hanger body is a hook for suspending a hanger ring configured on the object to be hanged.

According to a further embodiment of the present disclosure, the hanger body and the base are integrally formed as a unitary body, and the hanger body is a hanger knob. The hanger knob has a neck and a spacing bulge ring located at the external end of the neck. The hanger knob is used for suspending a hanger hole configured on the object to be hanged and protecting the object to be hanged from moving outwards and falling off by the spacing bulge ring.

According to still a further embodiment of the present disclosure, the spacing bulge ring has a tapered peripheral face, which is convenient for guiding the hanger knob into the hanger hole of the object to be hanged.

According to yet still a further embodiment of the present disclosure, a bonding groove is arranged on the external end surface of the spacing bulge ring. After the object to be hanged is suspended, an ornament is bonded into the bonding groove for sheltering and beautifying.

According to an embodiment of the present disclosure, at least a through hole is arranged passing through the neck, so that a hanger member can penetrate the through hole to suspend the object to be hanged.

### BRIEF DESCRIPTION OF THE DRAWINGS

In order to make the foregoing as well as other purposes, features, advantages and embodiments of the present disclosure more apparent, the accompanying drawings are described as follows:

FIG. 1 depicts an external view of an electrostatic-film adhesive hanger according to a first embodiment of the present disclosure;

FIG. 2 depicts an enlarged view of part A of the electrostatic-film adhesive hanger depicted in FIG. 1;

FIG. 3 depicts an exploded view of the electrostatic-film adhesive hanger depicted in FIG. 1;

FIG. 4 depicts a sectional view of the electrostatic-film adhesive hanger depicted in FIG. 1 and shows a schematic view for use of the electrostatic-film adhesive hanger;

FIG. 5 depicts an external view of an electrostatic-film adhesive hanger according to a second embodiment of the present disclosure;

FIG. 6 depicts an enlarged view of the hanger body unit in the electrostatic-film adhesive hanger depicted in FIG. 5; and

FIG. 7 depicts an external view of an electrostatic-film adhesive hanger according to a third embodiment of the present disclosure.

### DETAILED DESCRIPTION

The foregoing and other technical contents, features and functions of the present disclosure will be clearly shown in the following detailed description of embodiments with reference to the accompanying drawings.

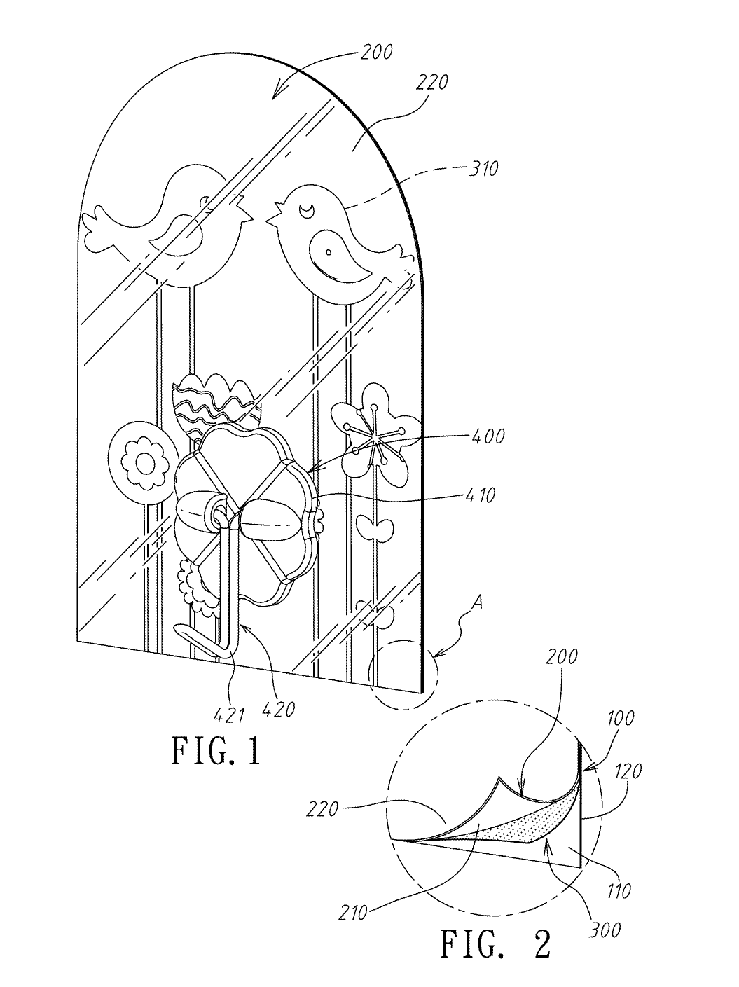

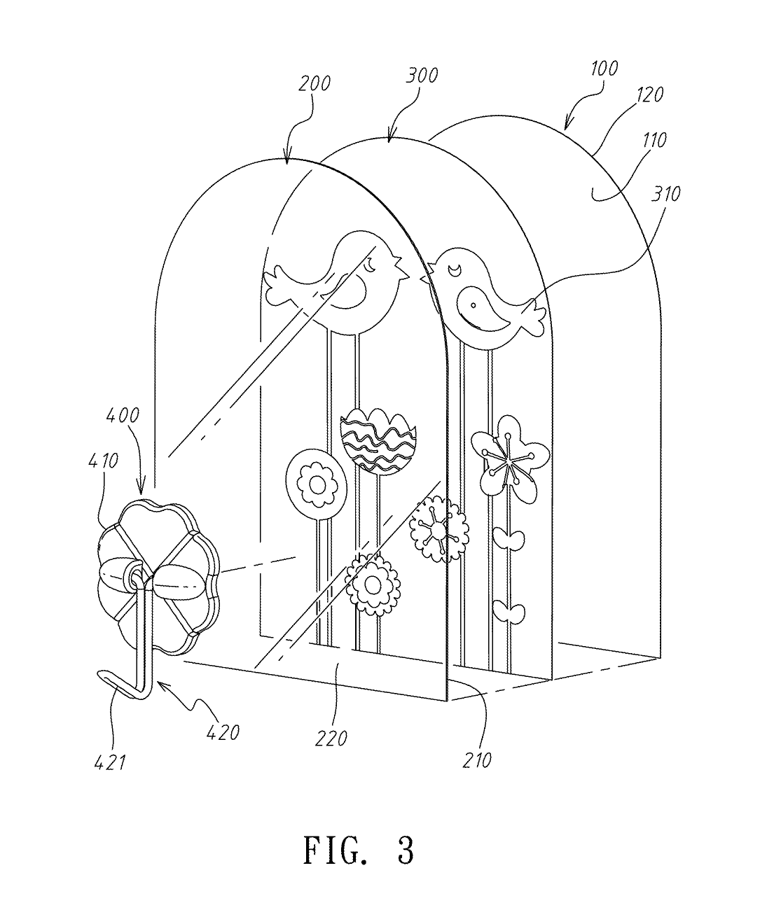

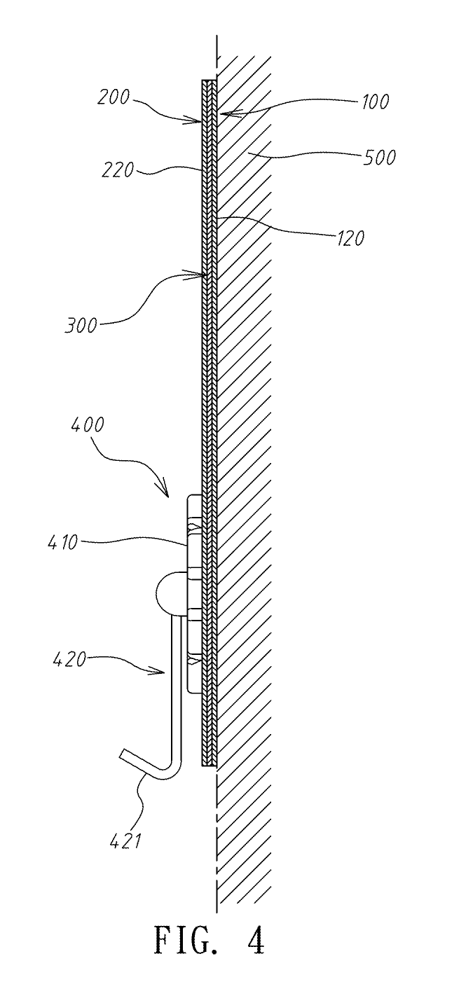

FIGS. 1-4 respectively depict an external view, a partially enlarged view, an exploded view and a sectional view of an electrostatic-film adhesive hanger according to a first embodiment of the present disclosure and show a schematic view for use of the electrostatic-film adhesive hanger. As depicted in these drawings, the electrostatic-film adhesive hanger according to the first embodiment of the present disclosure includes an electrostatic-film layer 100, a transparent protection layer 200, a printed layer 300 and a hanger body unit 400.

The electrostatic-film layer 100 has the electrostatic adsorption. The electrostatic-film layer 100 has an internal surface 110 and an external surface 120 on the reverse side.

The transparent protection layer 200 has a good perspectivity and toughness. The transparent protection layer 200 has an internal surface 210 and an external surface 220 on the reverse side.

The printed layer 300 is adhered between the internal surface 110 of the electrostatic-film layer 100 and the internal surface 210 of the transparent protection layer 200. A pattern 310 is arranged on the side of the printed layer 300 facing the transparent protection layer 200, so that the whole electrostatic-film adhesive hanger provides visual aesthetics, and the transparent protection layer 200 can be used for protecting the printed layer 300 from damage.

The hanger body unit 400 includes a base 410 and a hanger body 420. The base 410 of the hanger body unit 400 is adhered on the external surface 220 of the transparent protection layer 200, and the hanger body is arranged on the base 410. The hanger body 420 may be any means for hanging or holding the object, such as a hook, a hanging frame or a hanging knob. In the first embodiment, the hanger body 420 is shown as a hook 421, which is mounted on the base 410. The hook 421 is used for suspending the hanger ring (not shown) configured on the object to be hanged.

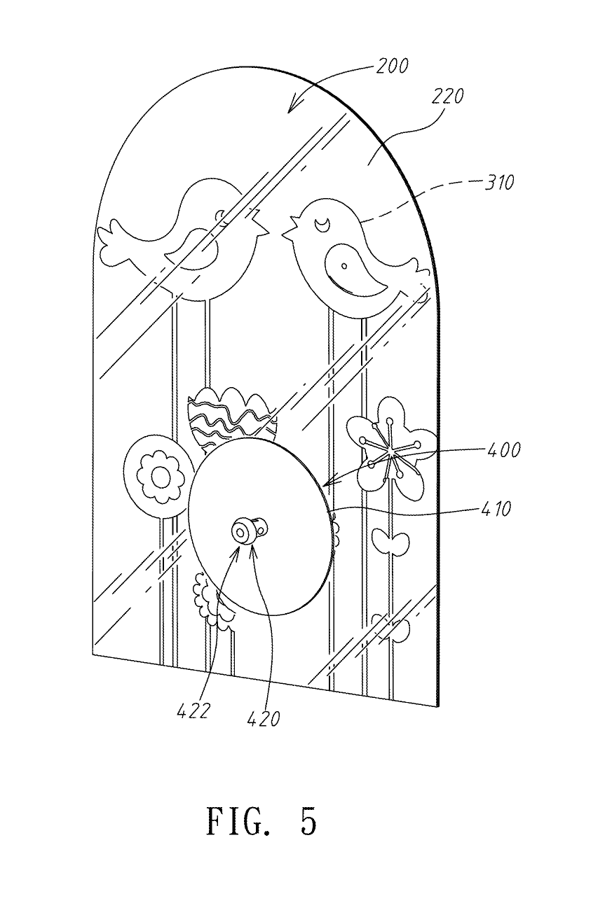

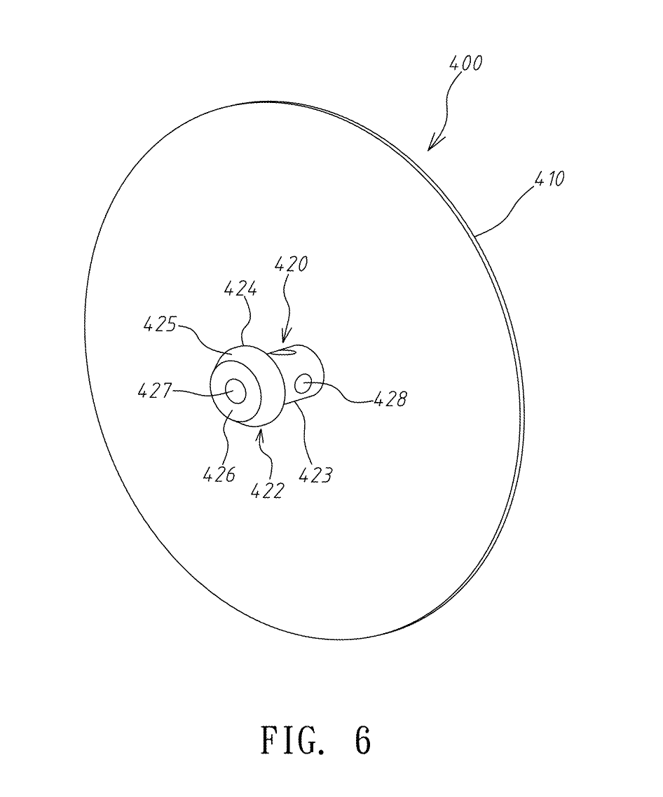

FIGS. 5 and 6 respectively depict an external view and a partially enlarged view of an electrostatic-film adhesive hanger according to a second embodiment of the present disclosure. The electrostatic-film adhesive hanger depicted in the second embodiment has a structure similar to the structure depicted in the above first embodiment. The difference is that in the second embodiment the hanger body 420 and the base 410 are formed as a whole, and the hanger body 420 is a hanger knob 422. The hanger knob has a neck 423 and a spacing bulge ring 424 located at the external end of the neck. The hanger knob 422 and the neck 423 are used for suspending the hanger hole (not shown) configured on the object to be hanged, and the spacing bulge ring 424 protects the object to be hanged from moving outwards and falling off.

The spacing bulge ring 424 of the hanger knob 422 has a tapered peripheral face 425, so that the hanger knob 422 can be guided into the hanger hole of the object to be hanged. Furthermore, a bonding groove 427 is configured on the external end surface 426 of the spacing bulge ring 424. After the object to be hanged is suspended, an ornament (not shown) is bonded into the bonding groove 427 for sheltering and beautifying.

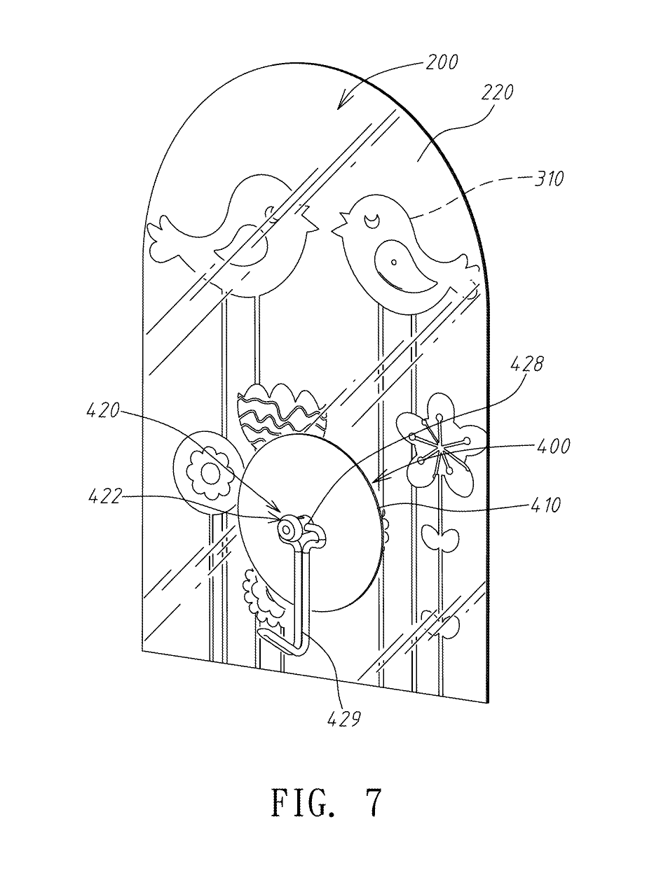

FIG. 7 depicts an external view of an electrostatic-film adhesive hanger according to a third embodiment of the present disclosure. It shows that two through holes 428 are arranged passing through the neck 423 of the hanger knob 422, so that a hanger member 429 can penetrate the through holes. As depicted in the first embodiment, the hanger member 429 can be used for suspending the object to be hanged.

During attaching of the electrostatic-film adhesive hanger according to an aspect of the present disclosure, the external surface 120 of the electrostatic-film layer 100 is attached to a wall 500. The whole electrostatic-film adhesive hanger can be steadily adsorbed to the wall 500 due to the electrostatic adsorption of the electrostatic-film layer 100, maintaining a steady adsorption force without emergency of falling off from the wall due to various factors such as the physical recovery, moisture, mildewing and glue hardening. Moreover, the electrostatic-film adhesive hanger has the visual aesthetics due to the printed layer 300. Furthermore, the transparent protection layer 200 has the clear perspectivity and is used for protecting the printed layer 300 from damage. The hanger or the hanger knob is used for suspending the object to be hanged, and the whole using effect is good. In view of the above, the purposes of the present disclosure are realized.

Although the present disclosure has been disclosed with reference to the above embodiments, these embodiments are not intended to limit the present disclosure. Those skilled in the art can make various variations and modifications without departing from the spirit and scope of the present disclosure. Thus, the scope of the present disclosure should be defined by the appended claims.

What is claimed is:

1. An electrostatic-film adhesive hanger, comprising:
an electrostatic-film layer having an internal surface and an external surface on a reverse side;
a transparent protective film layer having an internal surface and an external surface on a reverse side;
a printed layer adhered between the internal surface of the electrostatic-film layer and the internal surface of the transparent protection layer, wherein a pattern is arranged on one side of the printed layer facing the transparent protection layer; and
a hanger body unit adhered on the external surface of the transparent protection layer.

2. The electrostatic-film adhesive hanger of claim 1, wherein the hanger body unit comprises a base and a hanger body, the base is adhered on the external surface of the transparent protection layer, and the hanger body is arranged on the base.

3. The electrostatic-film adhesive hanger of claim 2, wherein the hanger body is a hook.

4. The electrostatic-film adhesive hanger of claim 2, wherein the hanger body and the base are integrally formed, the hanger body is a hanger knob, and the hanger knob has a neck and a spacing bulge ring located at the external end of the neck.

5. The electrostatic-film adhesive hanger of claim 4, wherein the spacing bulge ring has a tapered peripheral face.

6. The electrostatic-film adhesive hanger of claim 5, wherein a bonding groove is arranged on an external end surface of the spacing bulge ring.

7. The electrostatic-film adhesive hanger of claim 4, wherein at least a through hole is arranged passing through the neck.
